(19) United States
(12) Patent Application Publication
(10) Pub. No.: US 2002/0069831 A1
(43) Pub. Date: Jun. 13, 2002

(54) Method for manufacturing herring roe on kelp

(76) Inventor: Stephen Clark, Brier, WA (US)

Correspondence Address: ALAN J. HOWARTH, P.O. BOX 1909, SANDY, UT, 84091-1909, US

(21) Appl. No.: 09/734,341

(22) Filed: Dec. 11, 2000

Related U.S. Application Data
(60) Provisional application No. 60/170,249, filed on Dec. 10, 1999.

(51) Int. Cl. A01K 61/00

(52) U.S. Cl. 119/215; 119/217; 119/221

(57) ABSTRACT

A method for manufacturing herring roe on kelp is described. The method comprises sandwiching kelp between layers of uncured herring roe in a mold made of a mesh material. The mold containing the roe and kelp is submerged in salt water such that the eggs adhere to the kelp and to each other. The outer surface of the eggs on kelp is textured to yield a natural appearance by dipping the eggs on kelp in a brine containing uncured eggs or by directing a stream of uncured eggs on the cured eggs on kelp until the desired appearance is obtained. Alternatively, a stream of uncured eggs can be directed against a piece of kelp originally having no eggs adhering to it until a layer of eggs builds up on the sides of the kelp to a selected thickness. Eggs on kelp prepared in this manner avoid contaminants, and the quality and freshness of the product can be controlled.

### CROSS-REFERENCE TO RELATED APPLICATIONS

This application claims the benefit of U.S. Provisional Application No. 60/170,249, filed Dec. 10, 1999.

### STATEMENT REGARDING FEDERALLY SPONSORED RESEARCH OR DEVELOPMENT

Not applicable.

### BACKGROUND OF THE INVENTION

This invention relates to a food product. More particularly, the invention relates to a method for manufacturing a herring roe on kelp product.

Herring is considered the most important food fish in the world. It belongs to the family of fishes that also includes the shad, menhaden, sardine, and alewife. Herring abound along the coasts in the temperate and colder parts of the North Pacific and North Atlantic oceans. The Atlantic herring is one of the most numerous of all the vertebrate animals on earth. Vast numbers are also taken from the North Sea, but overfishing of herring in the North Sea made breeding stock decline greatly in the 1970's. To reverse the decline, several countries took steps to restrict herring fishing in North Sea waters. By the mid-1980's, herring stock began to increase. The herring fishery in the western Pacific Ocean has also declined due to overfishing and pollution.

Millions of herring swim close together near the surface of the water in areas ranging from 6 to 20 square miles. Herring spend part of the time in deep water, then migrate to shallower coastal waters where they lay their eggs. A female deposits from 20,000 to 185,000 eggs, depending on her size. The eggs settle to the bottom, where they cover seaweed and rocks for miles.

Fisherman find the great schools of herring, called shoals, by watching for the vast numbers of sea birds that hover over the schools, and by the light or luminescence caused in the sea water by the swimming herring. Schools are also detected by electronic devices.

Fishermen usually catch herring in large nets. They go to a spot where a large number of herring are seen and let out an immense net. The crew then rows along the edges of the net in small boats and forces the mass of fish near the center. Then, when as many herring as possible have been surrounded, the boat approaches and many thousands of the fish are raised in the large net and thrown into the boat.

About 2.3 million metric tons of herring are caught each year. The former Soviet Union leads in the number of fish caught. American fisherman catch most of their herring in the Atlantic between Cape Cod and the Bay of Fundy, although a significant herring fishery exists along the western coasts of Alaska, Canada, Washington, Oregon, and California.

Many herring are frozen and used for bait in the halibut and cod fisheries. Many millions of herring are made into fertilizer, and the oil is extracted for lubricating machinery and for other purposes. Others are pickled or smoked, and large quantities are eaten fresh. Herring roe is considered a delicacy in some countries, such as Japan. Much of the information set forth above is found in World Book Encyclopedia Herring (1989).

Herring roe is harvested by catching the fish by seine or gill net methods. The fish is frozen whole and, after freezing, the egg sac or skein has formed into a single structure. There are two skeins in each fish. The skeins are removed from the fish, brined, and sold principally to the Japanese market as kazanoko. Under current prices, this product is sold at retail for $8.00 to $20.00 per pound.

Another herring product of particular interest in the Japanese market is herring roe on kelp. This product is prepared by suspending fresh kelp in the ocean near or in a natural herring spawning area. The fresh kelp is tied to ropes and suspended in the water from a floating raft structure. The raft is anchored at a selected location where the harvester believes the herring will spawn. Alternatively, the raft is anchored inside an enclosure bounded by a net, and live herring caught by seine are also placed inside the enclosure. When the herring spawn, the eggs naturally stick to anything they contact. As spawning proceeds, the kelp hanging in the water become coated with a layer of eggs. The thickness of the coat can vary from very sparse coverage to greater than an inch in thickness on both sides of the kelp. This product is sold in Japan as kazanoko kunbo. Depending on the quality and thickness of the product, it will sell for prices ranging from $10.00 to $100.00 per pound. The average wholesale price for #1 grade ranges from $25.00 to $50.00 per pound.

The value and quality of the herring roe on kelp product can vary due to several factors. Defects in the product can include the trapping of sand or other matter suspended in the water between the kelp and eggs as the spawn occurs. Heavy winds during the spawn can churn up the ocean floor, resulting in a poor quality product due to sand and other matter trapped between the eggs and kelp. Further, the kelp may be placed in an area where very little spawn activity occurs, resulting in sparse coverage of the kelp and the necessity of leaving the kelp suspended in the water for a long period of time to obtain adequate coverage, which compromises the freshness of the product. Still further, the food safety of herring roe on kelp produced according to this method can be compromised by contamination from oil spills, rubbish dumped on beaches or in the ocean, and the like.

In view of the above, it would be a significant advancement in the art to provide a method for controlling the quality of the herring roe on kelp product by increasing freshness and reducing or eliminating defects of extraneous matter in the product. It would also be an advancement in the art to provide a method for manufacturing the herring roe on kelp product wherein the coverage of eggs on the kelp can be controlled. Further, it would also be an advancement in the art to provide a method for making herring roe on kelp wherein there is greater control over food safety, such as eliminating contamination from oil spills and rubbish on beaches or in the water.

### BRIEF SUMMARY OF THE INVENTION

It is an object of the present invention to provide a method for manufacturing herring roe on kelp.

It is also an object of the invention to provide a method for manufacturing herring roe on kelp wherein there is control over the quality of the product wherein contaminants are reduced or avoided, freshness and safety are maximized, and coverage of the kelp by eggs is controlled.

These and other objects are addressed by providing a method for manufacturing herring roe on kelp comprising:

(a) extracting roe from fresh herring such that the roe is pliable and supple, and separating individual eggs from the outer membrane;

(b) providing a mold comprising a porous wall enclosing an interior compartment for receiving eggs and kelp, the porous wall being comprised of mesh material such that water can pass into and out of the compartment but the individual eggs are retained in the compartment, and placing individual eggs and kelp in the interior compartment of the mold such that the kelp is sandwiched between layers of selected thickness of individual eggs;

(c) curing the individual eggs such that such individual eggs adhere to each other and to the kelp and leeching out any blood that may be present by submerging the mold containing the eggs and kelp in a brine; and

(d) texturing the outer surface of the cured eggs on the kelp by adhering additional uncured eggs to the cured eggs on the kelp in a random pattern.

Preferably, the curing and leeching comprises submerging the mold containing the eggs and kelp in a brine comprising about 2.5% to about 6% by weight of sodium chloride for about 12 hours. In a preferred embodiment of the invention this brine is sea water. This curing and leeching step can be repeated. After the initial curing and leeching steps, the roe on kelp can be preserved by freezing or by successively submerging the roe on kelp in brines comprising about 30%, 70%, and 100% by weight of sodium chloride for about 12 hours each. Texturing of the outer surface of the roe on kelp is preferably carried out by dipping the cured roe on kelp in a brine containing uncured eggs such that the uncured eggs adhere to the outer surface of the roe on kelp, or by directing a stream of uncured eggs against the outer surface of the roe on kelp, thereby yielding a natural appearance.

Another preferred embodiment of the invention comprises:

(a) extracting roe from fresh herring such that the roe is pliable and supple, and separating individual eggs from the outer membrane;

(b) directing a stream of uncured herring eggs against the sides of a piece of kelp such that the eggs adhere to the kelp and to each other until a layer of eggs builds up on the kelp to a selected thickness; and

(c) submerging the kelp with the eggs adhering thereto in a brine for curing the eggs and leeching out any blood that may be present.

Still another preferred embodiment of the invention comprises:

(a) extracting roe from fresh herring such that the roe is pliable and supple, and separating individual eggs from the outer membrane;

(b) dying a portion of the separated individual eggs with an edible dye such that the resulting dyed eggs are distinguishable by color from undyed eggs;

(c) providing a mold comprising a porous wall enclosing an interior compartment for receiving eggs and kelp, the porous wall being comprised of mesh material such that water can pass into and out of the compartment but the individual eggs are retained in the compartment and the porous wall further having a recess configured for forming a raised design on the roe on kelp;

(d) placing dyed eggs in the recess and placing undyed eggs and kelp in the interior compartment of the mold such that the kelp is sandwiched between layers of selected thickness of undyed eggs; and

(e) curing the dyed and undyed eggs such that such undyed eggs adhere to each other and to the kelp and the dyed eggs adhere to the undyed eggs in a raised design configuration, and leeching out any blood that may be present by submerging the mold containing the eggs and kelp in a brine.

### BRIEF DESCRIPTION OF THE SEVERAL VIEWS OF THE DRAWINGS

FIG. 1 shows a perspective view of a prior art apparatus for use in making herring roe on kelp.

FIGS. 2 and 3 show an end view and a top view, respectively, of a an illustrative mold in an open position for use in manufacturing herring roe on kelp according to the present invention.

FIG. 4 shows a sectional view of a mold according to FIGS. 2 and 3, containing roe and kelp.

FIG. 5 shows a top view of a first member of a mold having a recess formed in the wall thereof for forming a design in the roe on kelp product according to the present invention.

### DETAILED DESCRIPTION

Before the present method for manufacturing herring roe on kelp is disclosed and described, it is to be understood that this invention is not limited to the particular configurations, process steps, and materials disclosed herein as such configurations, process steps, and materials may vary somewhat. It is also to be understood that the terminology employed herein is used for the purpose of describing particular embodiments only and is not intended to be limiting since the scope of the present invention will be limited only by the appended claims and equivalents thereof.

It must be noted that, as used in this specification and the appended claims, the singular forms “a,” “an,” and “the” include plural referents unless the context clearly dictates otherwise. Thus, for example, reference to “a mold” includes reference to two or more of such molds, reference to “a mesh material” includes reference to one or more of such mesh materials, and reference to “a brine” includes reference to two or more of such brines.

In describing and claiming the present invention, the following terminology will be used in accordance with the definitions set out below.

As used herein, “comprising,” “including,” “containing,” “characterized by,” and grammatical equivalents thereof are inclusive or open-ended terms that do not exclude additional, unrecited elements or method steps. “Comprising” is to be interpreted as including the more restrictive terms “consisting of” and “consisting essentially of.”

As used herein, “consisting of” and grammatical equivalents thereof exclude any element, step, or ingredient not specified in the claim.

As used herein, “consisting essentially of” and grammatical equivalents thereof limit the scope of a claim to the specified materials or steps and those that do not materially affect the basic and novel characteristic or characteristics of the claimed invention.

FIG. 1 shows a raft 10 for preparing herring roe on kelp according to the prior art. The raft has coupled to it a plurality of ropes 12 to which are tied pieces of kelp 14. The raft, including the ropes and kelp, is anchored in the ocean at a location selected by the harvester such that herring eggs produced by the spawning herring will adhere to the kelp. The kelp is left in the ocean for as long as it takes for the desired amount of eggs to accumulate on the kelp. It will be evident that selection of a site for anchoring the raft is of paramount importance in obtaining a quality product. If the raft is anchored at a location where few eggs are present, then the layer of eggs on the kelp will be less than desired. If the raft is anchored too early or too late in the spawning season, then the kelp will be left in the water for a longer period of time than if the raft is anchored at the height of the spawn. This means that the kelp and eggs are left in the water for a longer period of time than would be ideal for quality and freshness. Further, the process is also susceptible to the vagaries of weather and environment. Sand and other contaminants suspended in the water will adhere to the eggs and kelp, reducing the quality of the product.

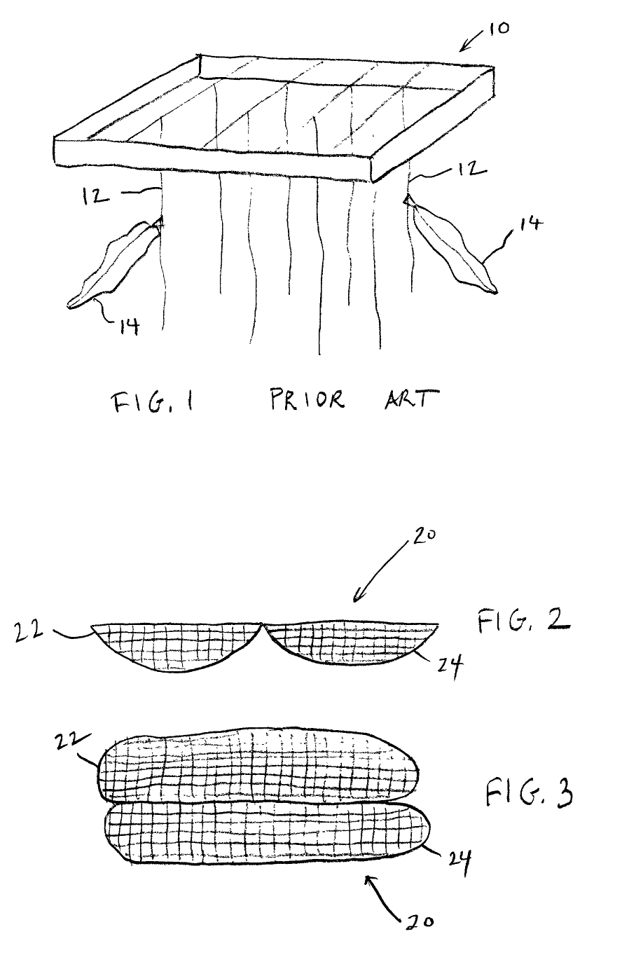

FIGS. 2-4 show an illustrative mold for making the herring roe on kelp product according to the present invention. The mold 20 comprises a first member 22 and a second member 24 that, when secured together, form a housing enclosing a compartment 26. The first and second members are preferably made of a wire mesh material, although any other material of sufficient strength and resistance to salt water would be suitable. For example, a plastic material could also be used for the first and second members. The size of the openings in the mesh materials is sufficiently small to hold the herring eggs inside the compartment of the mold, but allows the flow of water into and out of the compartment.

After the herring are caught, the roe is extracted from the fish, preferably within about 48-60 hours, such that the eggs are pliable and supple. If too much time passes between the death of the fish and extracting the roe, then the eggs harden and become unsuitable for use in making the roe on kelp product. The eggs as they are removed from the fish are usually contained in the egg sacs or skeins. The individual eggs are removed from the skeins according to methods well known in the art, such as rubbing them through a screen to free them from the enclosing tissue or membrane.

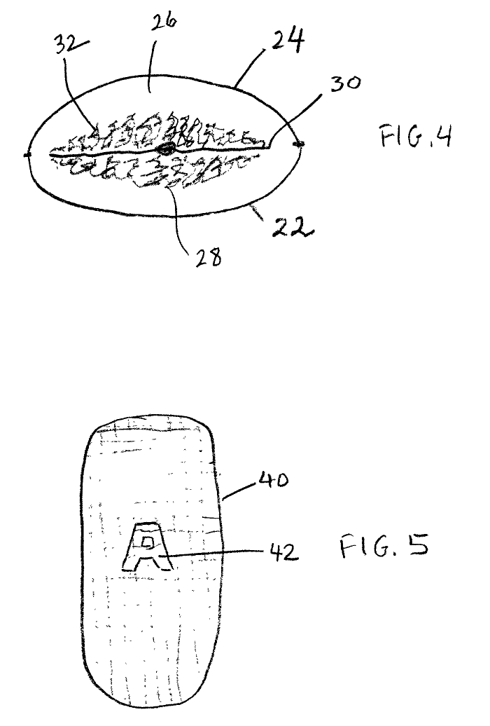

Referring now to FIG. 4, the individual eggs are then placed in the first member 22 of the mold to form a layer of eggs 28 of a selected thickness. The selected thickness will generally be in the range of about 0.25 inch to 1 inch. Then, a strip of kelp 30 is placed on top of the layer of eggs. Next, another layer of eggs 32 is place on top of the kelp, thus sandwiching the kelp between layers of eggs. The second member 24 of the mold is then secured to the first member of the mold, thus trapping the eggs and kelp in the compartment 26 formed by the two members.

The mold containing the eggs and kelp is then placed in a container of salt brine. Preferably, the salt brine has a sodium chloride content of about 2.5% to about 6% by weight. The salt brine could be sea water. If sea water is used, it would be preferable to filter the sea water prior to use such that solids, such as sand, are removed. The eggs and kelp are held in the salt water for a period of time sufficient for the eggs to cure and to leech out blood that may have contaminated the eggs in the process of removing them from the fish. In the curing process, the eggs become very sticky and adhere to anything they touch, namely the kelp and each other. The eggs will also adhere to the mold, thus it is advantageous to apply a releasing agent to the mold prior to use such that the eggs do not adhere tightly to the mold. Suitable releasing agents include edible oils, such as vegetable oil and the like. The eggs and kelp are preferably cured in the brine for about 12 hours. This curing step can be repeated one or more times by removing the mold containing the eggs and kelp from the brine and then placing the mold containing the eggs and kelp into a fresh brine solution. This additional curing leeches out any residual blood that may be present and additionally cures the eggs.

At this stage of the process, the eggs on kelp could be removed from the mold and stored frozen. This is a more convenient method for storing the eggs and kelp, as far as the consumer is concerned, as will become apparent momentarily.

The traditional method of storing the cured eggs on kelp, however, is to place the product in increasingly more concentrated salt solutions, until the eggs on kelp are finally stored in 100% w/v salt solution. An illustrative method of achieving this condition is by submerging the eggs on kelp in one or more changes of 30% w/v salt solution, 70% w/v salt solution, and then 100% w/v salt solution. The period of time that the product is held in each concentration of salt solution is preferably about 12 hours. The product preserved in this manner is too salty for direct consumption. The consumer must soak the product in water for a sufficient period of time to leech out the salt until the product has a sufficiently low salt concentration as to be edible. This is the traditional method of preserving roe on kelp, but the amount of time needed to wash out the salt is significant.

While the steps described above are sufficient for making a roe on kelp product, the product prepared as described does not appear to be the natural product because the outer surface of the product takes on an appearance that resembles the inner surface of the mold. Thus, the product is not entirely satisfactory from a commercial standpoint. This can be remedied as follows. After the initial curing step in salt brine, the roe on kelp product is removed from the mold and then dipped in salt brine containing individual eggs that have not yet been cured. The eggs in the brine adhere to the outer surface of the roe on kelp in a random manner, thus producing a roe on kelp product with a natural outer appearance. Another method for texturing the outer surface of the roe on kelp product comprises removing the mold from the salt brine after the initial curing step, dipping the roe on kelp into a salt brine, and, while the roe on kelp is submerged in the brine, directing a stream of fresh eggs at the roe on kelp such that the eggs adhere to the roe on kelp in a random manner, thus giving the product a natural appearance. Following either of these steps for texturing the outer surface of the roe on kelp product to give it a natural appearance, the additional curing steps and salting steps are carried out as described above.

Another preferred embodiment of the invention is a variation of the texturing method described above. In this method, kelp without any eggs attached to it is placed in a salt brine, and then a stream of uncured eggs is directed against the sides of the kelp. The eggs adhere to the surfaces of the kelp and to each other. The stream of eggs directed against the kelp is maintained until a layer of eggs builds up on each side of the kelp leaf to a selected thickness. The resulting roe on kelp is then cured in salt solutions as described above.

It is another embodiment of the invention to make a novelty roe on kelp product having a design formed in the outer surface of the roe on kelp product, the design being formed of eggs of a different color than the remainder of the eggs on the product. The design can be in the shape of letters, a geometric design, or any other selected design. As shown in FIG. 5, a special mold is used for making this product, wherein the first member 40 comprises a portion of the wall thereof containing a recess 42 as viewed from the inner side of the mold. This recess is filled with eggs that have been dyed a color that can be distinguished from the color of the natural or undyed eggs. Next, a layer of undyed eggs is placed over the dyed eggs, filling the first member in a manner similar to what was described above. Then, a piece of kelp is placed over the layer of eggs, and then another layer of eggs is placed over the kelp, the second member of the mold is secured over the layered eggs and kelp, and the eggs and kelp are cured in brine as described above. The resulting roe on kelp product, after being removed from the mold, contains the design on one surface of the roe on kelp product wherein the design is of a distinctive color as compared to the natural color of the eggs.

1. A method for manufacturing herring roe on kelp comprising:
(a) extracting roe from fresh herring such that the roe is pliable and supple, and separating individual eggs from the outer membrane;
(b) providing a mold comprising a porous wall enclosing an interior compartment for receiving eggs and kelp, said porous wall being comprised of mesh material such that water can pass into and out of the compartment but the individual eggs are retained in the compartment, and placing individual eggs and kelp in the interior compartment of the mold such that the kelp is sandwiched between layers of selected thickness of individual eggs;
(c) curing the individual eggs such that such individual eggs adhere to each other and to the kelp and leeching out any blood that may be present by submerging the mold containing the eggs and kelp in a brine; and
(d) texturing the outer surface of the cured eggs on the kelp by adhering additional uncured eggs to the cured eggs on the kelp in a random pattern.

2. The method of claim 1 wherein said curing and leeching comprises submerging the mold containing the eggs and kelp in a brine comprising about 2.5% to about 6% by weight of sodium chloride for about 12 hours.

3. The method of claim 2 wherein said brine is sea water.

4. The method of claim 2 further comprising repeating the curing and leeching step comprising submerging the mold containing the eggs and kelp in a brine comprising about 2.5% to about 6% by weight of sodium chloride for about 12 hours.

5. The method of claim 4 further comprising successively submerging the mold containing eggs and kelp in brines comprising about 30%, 70%, and 100% by weight of sodium chloride for about 12 hours each.

6. The method of claim 1 wherein said texturing comprises removing the cured eggs and kelp from the mold and then dipping the cured eggs and kelp in a brine containing uncured eggs such that the uncured eggs adhere to the outer surface of the eggs and kelp, thereby yielding a natural appearance.

7. The method of claim 1 wherein said texturing comprises removing the cured eggs and kelp from the mold, submerging the cured eggs and kelp in a brine, and directing a stream of uncured eggs at the cured eggs and kelp such that the uncured eggs adhere to the outer surface of the eggs and kelp, thereby yielding a natural appearance.

8. A method for manufacturing herring roe on kelp comprising:
(a) extracting roe from fresh herring such that the roe is pliable and supple, and separating individual eggs from the outer membrane;
(b) dying a portion of said separated individual eggs with an edible dye such that the resulting dyed eggs are distinguishable by color from undyed eggs;
(c) providing a mold comprising a porous wall enclosing an interior compartment for receiving eggs and kelp, said porous wall being comprised of mesh material such that water can pass into and out of the compartment but the individual eggs are retained in the compartment and said porous wall further having a recess configured for forming a raised design on the roe on kelp;
(d) placing dyed eggs in said recess and placing undyed eggs and kelp in the interior compartment of the mold such that the kelp is sandwiched between layers of selected thickness of undyed eggs; and
(e) curing the dyed and undyed eggs such that such undyed eggs adhere to each other and to the kelp and the dyed eggs adhere to the undyed eggs in a raised design configuration, and leeching out any blood that may be present by submerging the mold containing the eggs and kelp in a brine.

9. A method for manufacturing herring roe on kelp comprising:
(a) extracting roe from fresh herring such that the roe is pliable and supple, and separating individual eggs from the outer membrane;
(b) directing a stream of uncured herring eggs against the sides of a piece of kelp such that the eggs adhere to the kelp and to each other until a layer of eggs builds up on the kelp to a selected thickness; and
(c) submerging the kelp with the eggs adhering thereto in a brine for curing the eggs and leeching out any blood that may be present.
